(19) United States
(12) Patent Application Publication
(10) Pub. No.: US 2021/0086397 A1
(43) Pub. Date: Mar. 25, 2021

(54) STAGE MECHANISM, ADDITIVE MANUFACTURING DEVICE, AND ADDITIVE MANUFACTURING METHOD

(71) Applicant: SINTOKOGIO, LTD., Nagoya-shi, Aichi (JP)

(72) Inventors: Norihiro ASANO, Toyokawa-shi, Aichi (JP); Norihito FUJIWARA, Toyokawa-shi, Aichi (JP); Kazuya KOJIMA, Toyokawa-shi, Aichi (JP)

(73) Assignee: SINTOKOGIO, LTD., Nagoya-shi, Aichi (JP)

(21) Appl. No.: 16/970,414

(22) PCT Filed: Jan. 18, 2019
(86) PCT No.: PCT/JP2019/001541

§ 371 Date: Aug. 17, 2020

(30) Foreign Application Priority Data
Feb. 20, 2018 (JP) 2018-028131

(51) Int. Cl. B28B 1/00; B33Y 10/00; B33Y 30/00; B33Y 40/00; B28B 11/24; B33Y 50/02; B28B 17/00; B29C 64/165; B29C 64/232; B29C 64/245; B29C 64/379; B29C 64/393

(52) U.S. Cl. CPC B28B 1/001; B33Y 10/00; B33Y 30/00; B33Y 40/00; B28B 11/243; B33Y 50/02; B29K 2509/02; B29C 64/165; B29C 64/232; B29C 64/245; B29C 64/379; B29C 64/393; B28B 17/0081

(57) ABSTRACT

A stage mechanism for use in an additive manufacturing device for forming a three-dimensional shaped object by stacking layers, which are formed by a layer forming unit, on a layer-by-layer basis, the stage mechanism including a porous plate configured to adhere a flexible sheet by vacuum suction and a base supporting the porous plate and having a space defined inside of the base, and an inlet port configured to connect the space and a decompression device, wherein the base moves up and down relative to the layer forming unit of the additive manufacturing device so that the shaped object is formed on the flexible sheet adhered, by vacuum suction, to the porous plate, and a pore diameter of the porous plate is less than the thickness of the flexible sheet.

### TECHNICAL FIELD

The present disclosure relates to a stage mechanism, an additive manufacturing device, and an additive manufacturing method.

### BACKGROUND ART

Patent Document 1 discloses an additive manufacturing device for forming a three-dimensional shaped object by stacking layers, which are formed by a layer forming unit, on a layer-by-layer basis. This device comprises: a box-type shaping frame; an elevator base disposed in the shaping frame and movable up and down; a base plate placed on the elevator base; a material supply unit for supplying a raw material in an amount corresponding to the thickness of a single layer onto the base plate; and a layer forming unit for irradiating a surface of the raw material on the base plate with a laser beam.

### CITATION LIST

### Patent Document

Patent Document 1: Japanese Unexamined Patent Publication No. 2003-1368

### SUMMARY OF INVENTION

### Technical Problem

In the additive manufacturing device described in Patent Document 1, the shaped object is formed on the base plate, and, therefore, when removing the shaped object from the additive manufacturing device, the operator needs to scrape the shaped object off the base plate using a scraper such as a spatula. This operation may scratch the shaped object or the base plate, and is time consuming. In this technical field, there is demand for a stage mechanism, an additive manufacturing device, and an additive manufacturing method capable of reducing the operation time and obtaining a shaped object of high quality.

### Solution to Problem

One aspect of the present disclosure is a stage mechanism for use in an additive manufacturing device for forming a three-dimensional shaped object by stacking layers, which are formed by a layer forming unit, on a layer-by-layer basis. The stage mechanism includes a porous plate and a base. The porous plate is configured to adhere a flexible sheet by vacuum suction. The base supports the porous plate, and has a space defined inside of the base, and an inlet port configured to connect the space and a decompression device. The base moves up and down relative to the layer forming unit of the additive manufacturing device so that the shaped object is formed on the flexible sheet adhered, by vacuum suction, to the porous plate.

In this stage mechanism, the pressure in the space inside the base is reduced by the decompression device, and the porous plate adheres the flexible sheet thereto by vacuum suction caused by the pressure difference between the space and the atmospheric pressure. The base moves up and down to realize stacking of layers on a layer-by-layer basis while supporting the porous plate to which the flexible sheet has been adhered by vacuum suction. Hence, the layer forming unit can form the shaped object on the flexible sheet. When the reducing the pressure in the space inside the base is stopped, the vacuum suction adhesion to the porous plate is released. When the vacuum suction adhesion is released, the shaped object formed on the flexible sheet is easily separated together with the flexible sheet from the stage mechanism. Since the stage mechanism enables the removal of the shaped object from the stage mechanism without using a scraper, it is possible to avoid the shaped object or the base plate from being scratched. Thus, the stage mechanism is capable of reducing the operation time and obtaining the shaped object of high quality.

In one embodiment, the stage mechanism may include a drive unit configured to move the base up and down. In this case, the stage mechanism can change the relative position between the base and the layer forming unit by moving the base up and down.

In one embodiment, the layer forming unit may form the layer by irradiating a raw material containing a photocurable resin supplied on the flexible sheet, with light. In this case, the stage mechanism can move up and down so that the photocurable resin supplied on the flexible sheet can be irradiated with light on a layer-by-layer basis.

In one embodiment, the layer forming unit may form the layer by jetting a raw material containing a resin onto the flexible sheet, or by jetting a binder into a raw material supplied on the flexible sheet. In this case, the stage mechanism can move up and down for allowing the flexible sheet to be subjected to a jet of the raw material containing the resin or the raw material supplied on the flexible sheet to be subjected to a jet of the binder on a layer-by-layer basis.

In one embodiment, the raw material of the shaped object may contain a ceramic. In this case, the shaped object is a ceramic formed body. Since the ceramic formed body has low toughness, the ceramic formed body tends to crack easily when removing the ceramic formed body from the stage mechanism using a scraper. In this stage mechanism, since the shaped object can be removed from the stage mechanism without using a scraper, it is possible to avoid the ceramic formed body from being scratched.

In one embodiment, the raw material of the shaped object may be supplied onto the flexible sheet by a raw material supply unit moving in a horizontal direction. In the case where the raw material supply unit supplies the raw material while moving in the horizontal direction, if the flexible sheet is simply laid, there is a possibility that the flexible sheet is displaced in the horizontal direction by the movement of the raw material supply unit. Since the porous plate can adhere the flexible sheet by vacuum suction, it is possible to prevent a positional displacement of the flexible sheet in the horizontal direction during the supply of the raw material.

Another aspect of the present disclosure is an additive manufacturing device including the above-described stage mechanism. According to the additive manufacturing device, the same effects as the above-described stage mechanism are obtained.

Other aspect of the present disclosure is an additive manufacturing method for manufacturing a three-dimensional shaped object by stacking layers on a layer-by-layer basis. This method includes: adhering a flexible sheet, by vacuum suction, to a porous plate provided in a stage mechanism of an additive manufacturing device; forming the shaped object on the flexible sheet by moving the porous plate to which the flexible sheet has been adhered by vacuum suction, up and down relative to a layer forming unit of the additive manufacturing device; releasing the vacuum suction adhesion between the porous plate and the flexible sheet; unloading the shaped object formed on the flexible sheet from the additive manufacturing device together with the flexible sheet; and separating the shaped object and the flexible sheet unloaded from the additive manufacturing device.

According to the additive manufacturing method, the flexible sheet is adhered, by vacuum suction, to the porous plate provided in the stage mechanism of the additive manufacturing device. Then, the shaped object is formed on the flexible sheet adhered by vacuum suction. After forming the shaped object, the vacuum suction adhesion between the porous plate and the flexible sheet is released. After releasing the vacuum suction adhesion, the shaped object formed on the flexible sheet is unloaded together with the flexible sheet from the additive manufacturing device. Then, the shaped object and the flexible sheet unloaded from the additive manufacturing device are separated from each other. Thus, since the additive manufacturing method uses the flexible sheet, the shaped object can be easily removed from the stage mechanism without using a scraper. Hence, the additive manufacturing method is capable of reducing the operation time and obtaining the shaped object of high quality.

In one embodiment, in the separating the shaped object and the flexible sheet, the flexible sheet may be removed from the shaped object by bending the flexible sheet. According to this additive manufacturing method, it is possible to easily remove the flexible sheet from the shaped object.

In one embodiment, in the forming the shaped object on the flexible sheet, the raw material of the shaped object may be supplied onto the flexible sheet by a raw material supply unit moving in a horizontal direction. Since the porous plate can adhere the flexible sheet by vacuum suction, it is possible to prevent a positional displacement of the flexible sheet in the horizontal direction during the supply of the raw material.

In one embodiment, the additive manufacturing method may include firing the shaped object from which the flexible sheet has been separated. In this case, the additive manufacturing method enables removal of the shaped object such as a ceramic formed body before firing from the stage mechanism without using a scraper.

Other aspect of the present disclosure is an additive manufacturing device for forming a three-dimensional shaped object by stacking layers on a layer-by-layer basis. The additive manufacturing device includes: a porous plate configured to adhere a flexible sheet by vacuum suction; a base supporting the porous plate and having a space defined inside of the base, and an inlet port communicating with the space; a decompression device connected to the inlet port of the base; a layer forming unit configured to form the layer on the flexible sheet adhered, by vacuum suction, to the porous plate by the decompression device; a drive unit configured to move the base up and down relative to the layer forming unit; and a controller configured to control the drive unit so that the shaped object is formed on the flexible sheet adhered, by vacuum suction, to the porous plate by the decompression device.

In one embodiment, the drive unit may move the base up and down. In one embodiment, the drive unit may move the layer forming unit up and down. In one embodiment, the layer forming unit may form the layer by irradiating a raw material containing a photocurable resin supplied on the flexible sheet, with light. In one embodiment, the layer forming unit may form the layer by jetting a raw material containing a resin onto the flexible sheet, or by jetting a binder into a raw material supplied on the flexible sheet. In one embodiment, the raw material of the shaped object may contain a ceramic. In one embodiment, the raw material of the shaped object may be supplied onto the flexible sheet by a raw material supply unit moving in a horizontal direction.

### Advantageous Effects of Invention

According to the present disclosure, it is possible to reduce the operation time and obtain the shaped object of high quality.

### BRIEF DESCRIPTION OF DRAWINGS

FIG. 1 is a conceptual view of an additive manufacturing device.

FIG. 2 is a top view of a stage mechanism.

FIG. 3 is a cross-sectional view along the III-III line in FIG. 2.

FIG. 4 is a modified example of a porous plate.

FIG. 5 is a flowchart of an additive manufacturing method.

FIG. 6 is a view for explaining a layer stacking process.

FIG. 7 is a view for explaining the layer stacking process and an unloading process.

### DESCRIPTION OF EMBODIMENTS

Hereinafter, some embodiments will be described with reference to the accompanying drawings. In the description of the drawings, the same components are labeled with the same reference signs, and repeated description is omitted. The dimensional ratios in the drawings do not necessarily match the ratios in the description. The terms “up,” “down,” “left,” and “right” are based on the states shown in the drawings, and are for convenience.

(Additive Manufacturing Device)

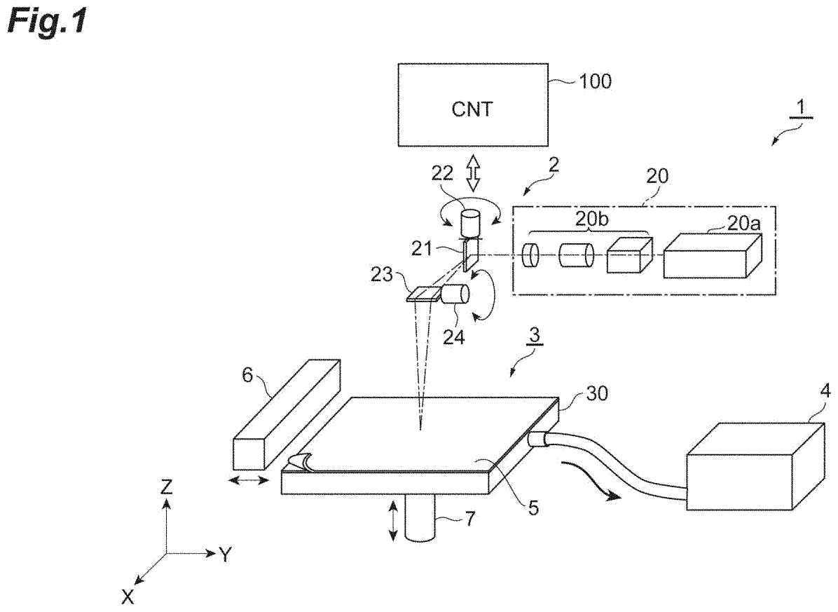

FIG. 1 is a conceptual view of an additive manufacturing device 1. The X direction and the Y direction in the drawing are horizontal directions, and the Z direction is a vertical direction. Hereinafter, the X direction is also referred to as a left-right direction, and the Z direction is also referred to as an up-down direction. The additive manufacturing device 1 forms a three-dimensional shaped object by stacking layers on a layer-by-layer basis. The additive manufacturing device 1 forms the shaped object on the basis of, for example, three-dimensional CAD data. The three-dimensional CAD data includes cross-sectional shape data of each individual layer. The additive manufacturing device 1 forms a cross section of the shaped object, layer-by-layer, on the basis of the cross-sectional shape data. As one example, the additive manufacturing device 1 forms a layer by irradiating a raw material containing a photocurable resin with light. The raw material is a material of the shaped object. The raw material may contain a ceramic, a metal, and other resin in addition to the photocurable resin. The photocurable resin is a synthetic organic material that absorbs light of a specific wavelength and changes into a solid.

The additive manufacturing device 1 comprises a layer forming unit 2, a stage mechanism 3, a decompression device 4, and a raw material supply unit 6.

The layer forming unit 2 is one constitutional component for forming a layer. The layer forming unit 2 irradiates the raw material supported by the stage mechanism 3, with light. As one example, the layer forming unit 2 comprises an optical unit 20 and light reflecting members 21, 23. The optical unit 20 includes, for example, a light source 20a and an optical member 20b, and emits light. The optical unit 20 outputs ultraviolet light as an example of light. The light reflecting members 21, 23 are, for example, Galvanometer mirrors, and change the optical path of light emitted from the optical unit 20. The light reflecting members 21, 23 are caused to rotate about a predetermined rotation axis by rotation drive units 22, 24. By controlling the rotation of the light reflecting members 21, 23, the layer forming unit 2 can irradiate a predetermined position in the horizontal direction with light, at a layer formation height position. The layer formation height position is a height predetermined as a height position where light irradiation takes place. When irradiated with light, the photocurable resin contained in the raw material cures, and therefore only a portion irradiated with light is formed as a layer. The layer forming unit 2 irradiates light to reproduce a cross-sectional shape based on the CAD data, and forms one layer of a cross-section of the shaped object.

The stage mechanism 3 comprises a base 30. The base 30 supports a porous plate on a top surface thereof, and has a space defined inside of the base. The base 30 is connected to the decompression device 4. The decompression device 4 is a device for reducing the pressure in the space inside the base 30. Examples of the decompression device 4 includes a compressor, and a vacuum pump. The decompression device 4 makes the space inside the base 30 to a negative pressure, for example, −0.1 MPa or less. Thus, the base 30 is configured to be capable of adhering the flexible sheet 5 onto the porous plate by vacuum suction. The details of the base 30 will be described later. The flexible sheet 5 is a soft sheet member. The flexible sheet 5 is a sheet formed from a metal or a resin. One example of the metal is aluminum, and one example of the resin is PET (polyethylene terephthalate), PP (polypropylene), PE (polyethylene), POM (polyacetal), or the like. As one example, the flexible sheet 5 has a thickness of about 10 μm to 2 mm.

The raw material supply unit 6 supplies the raw material onto the flexible sheet 5 adhered, by vacuum suction, to the porous plate. The raw material supply unit 6 supplies the raw material while moving, for example, in the horizontal direction (Y direction). As one example, the raw material supply unit 6 has a head for supplying the raw material, and a blade for smoothing the supplied raw material. By smoothing the raw material supplied from the head using the blade, the raw material in an amount corresponding to a single layer is supplied on the flexible sheet 5.

The base 30 moves up and down relative to the layer forming unit 2 so that the shaped object is formed on the flexible sheet 5 adhered, by vacuum suction, to the porous plate. As one example, the stage mechanism 3 includes a drive unit 7. The drive unit 7 is connected to the base 30, and moves the base 30 up and down. The drive unit 7 is, for example, an electric cylinder. The drive unit 7 moves the base 30 up and down by an amount of height of a single layer.

A controller 100 is hardware for controlling the entire additive manufacturing device 1. The controller 100 is constituted by, for example, a general-purpose computer having an arithmetic device such as a CPU (Central Processing Unit), a storage device such as a ROM (Read Only Memory), a RAM (Random Access Memory) and an HDD (Hard Disk Drive), and a communication device.

The controller 100 is communicably connected to the layer forming unit 2, the decompression device 4, the raw material supply unit 6, and the drive unit 7. The controller 100 outputs control signals to the layer forming unit 2, the decompression device 4, the raw material supply unit 6 and the drive unit 7, and controls operations. The controller 100 is connected to an operation panel (not shown) such as a touch panel, and operates the layer forming unit 2, the decompression device 4, the raw material supply unit 6, and the drive unit 7 in accordance with a command operation of an operator received through the operation panel. The controller 100 can also operate the layer forming unit 2, the decompression device 4, the raw material supply unit 6, and the drive unit 7 on the basis of the three-dimensional CAD data stored in the storage device. The controller 100 may control an operation of a later-described robot.

(Details of Stage Mechanism)

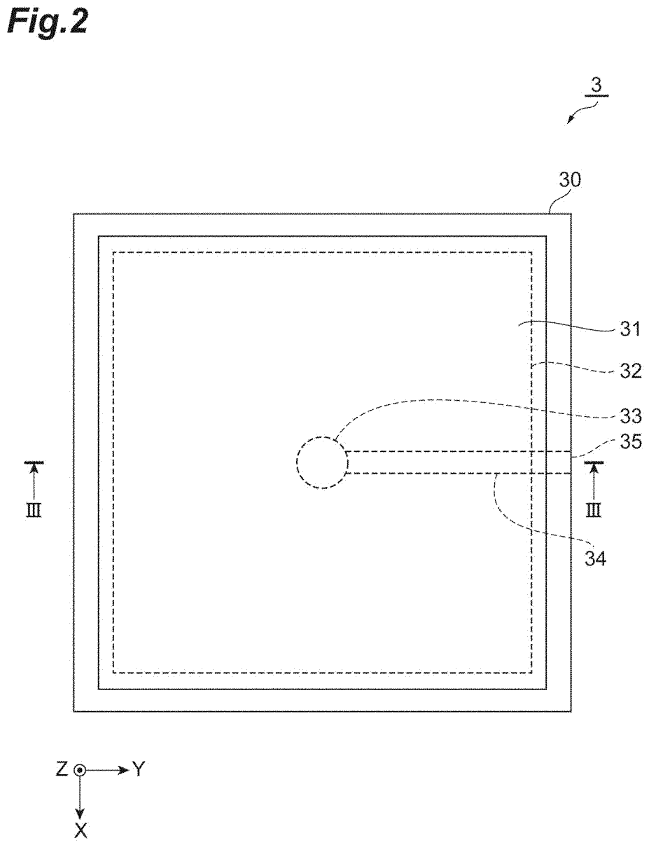

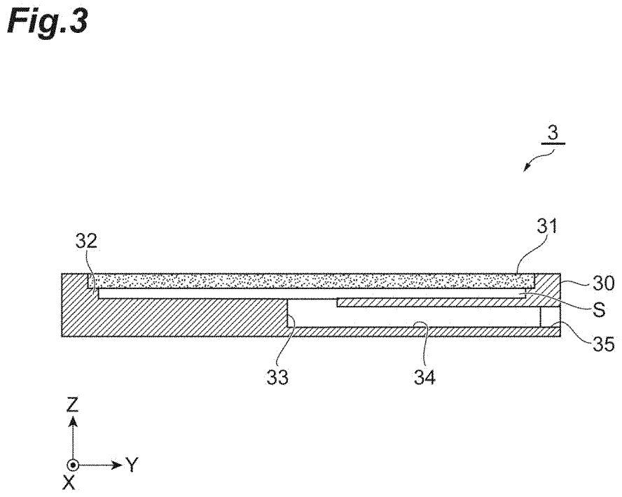

FIG. 2 is a top view of the stage mechanism 3. FIG. 3 is a cross-sectional view along the III-III line in FIG. 2. As shown in FIGS. 2 and 3, the stage mechanism 3 includes a porous plate 31 for adhering the flexible sheet 5 by vacuum suction, and the base 30.

The porous plate 31 is a plate member having a porous structure. The porous plate 31 has a plurality of pores, and allows gas to pass through. The porous plate 31 is formed from a porous material, such as ceramic, metal, and resin. As the porous material, for example, alumina ceramic or the like is used. As one example, the size of a pore is about 1 μm to 1 mm in pore diameter. Note that the pore diameter can be appropriately set in accordance with an application. For example, when it is desired to adhere the flexible sheet 5 having a smaller area than the porous plate 31 to the porous plate 31 by suction, the pore diameter may be 10 μm or less. In order to minimize suction marks, the pore diameter may be less than the thickness of the flexible sheet 5. For example, for the 2-mm thick flexible sheet 5, the pore diameter may be 1 mm or less.

The base 30 is a box-shaped frame, and has a space S defined inside of the base. An inner wall on an upper end side of the base 30 is provided with a step portion 32 protruding into the space S. The porous plate 31 is fitted on the top surface of the base 30, and is supported by the step portion 32. Thus, the porous plate 31 forms the ceiling of the space S.

The base 30 has an inlet port 35 for connecting the space S and the decompression device 4. The inlet port 35 is provided in a side portion of the base 30. The space S and the inlet port 35 communicate via a first internal flow path 33 extending in the Z direction and a second internal flow path 34 extending in the Y direction. The decompression device 4 is connected to the inlet port 35. When the decompression device 4 is activated, the space S has a negative pressure through the inlet port 35, the second internal flow path 34, and the first internal flow path 33. When the space S has a negative pressure, the porous plate 31 adheres the flexible sheet 5 placed on the top surface thereof, by vacuum suction. The flexible sheet 5 adhered by vacuum suction is secured at the placed position. When the negative pressure in the space S is released, the securing of the flexible sheet 5 is released. The base 30 is formed from, for example, aluminum.

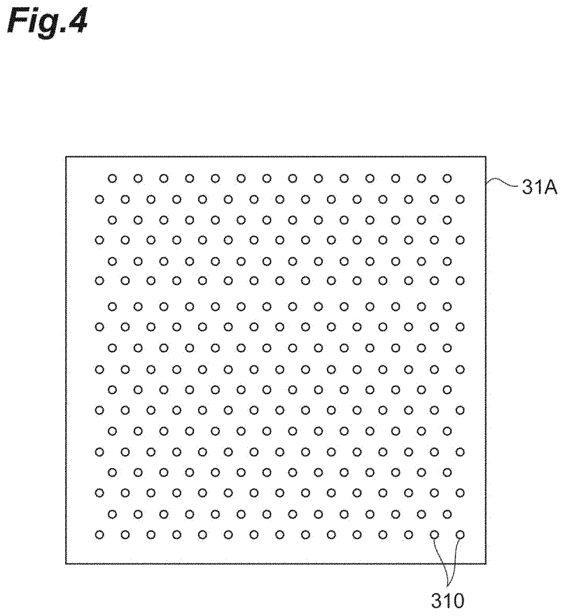

The porous plate 31 may also be formed by making pores in a plate member. FIG. 4 is a modified example of the porous plate. As shown in FIG. 4, a porous plate 31A is, for example, a metal plate, and a plurality of through-holes 310 are formed.

(Additive Manufacturing Method)

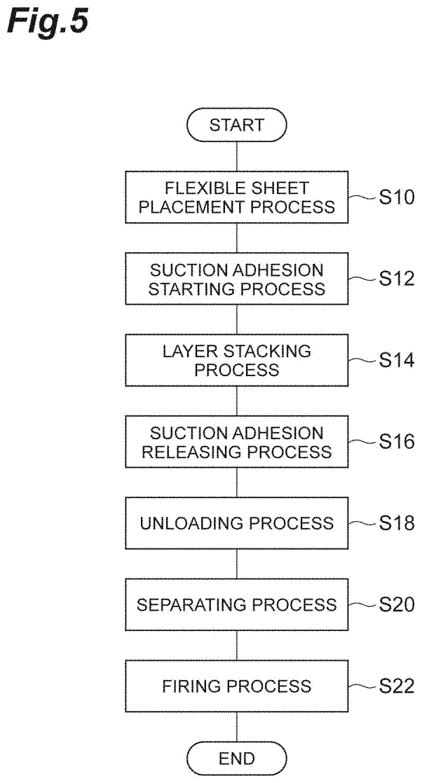

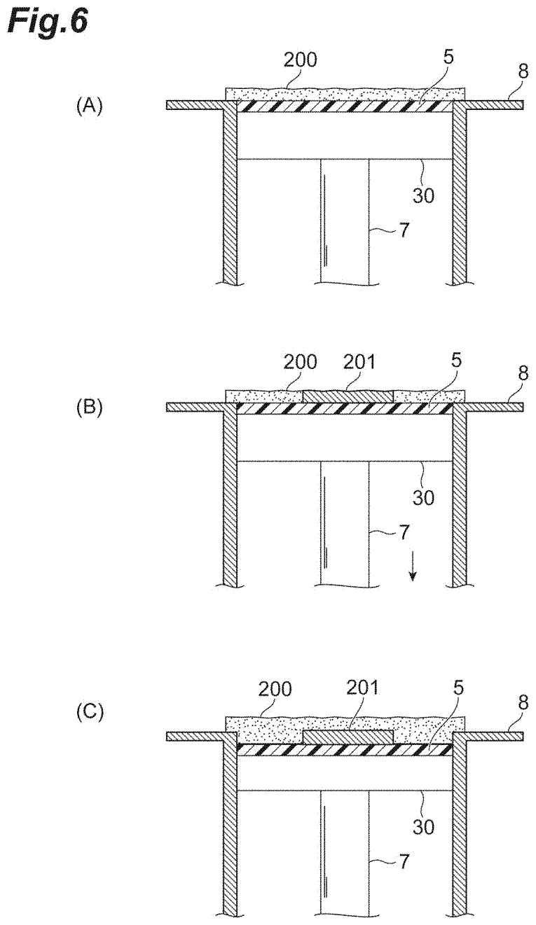

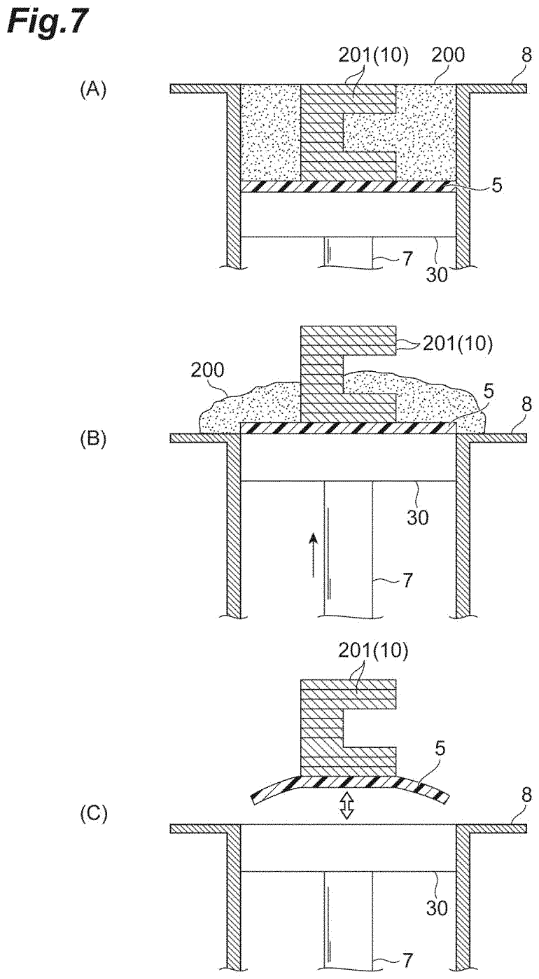

An additive manufacturing method is executed using the additive manufacturing device 1. Hereinafter, as one example, a case where a mixture of a ceramic and a photocurable resin is used as the raw material will be described. FIG. 5 is a flowchart of the additive manufacturing method. The flowchart will be explained with reference to FIGS. 6 and 7. FIG. 6 is a view for explaining a layer stacking process. FIG. 7 is a view for explaining the layer stacking process and an unloading process. In FIGS. 6 and 7, as one example, the base 30 is placed inside a shaping frame 8.

As shown in FIG. 5, first, as a placement process (step S10), the operator places the flexible sheet 5 on the top surface of the base 30. The placement process (step S10) may be executed by a robot.

Subsequently, the controller 100 operates the decompression device 4 as a suction adhesion starting process (step S12). With the operation of the decompression device 4, the pressure in the space S inside the base 30 is reduced. Consequently, the flexible sheet 5 adheres to the porous plate 31 by vacuum suction.

Subsequently, as the layer stacking process (step S14), the controller 100 forms a shaped object on the flexible sheet 5. In the layer stacking process (step S14), the shaped object is formed on the flexible sheet 5 by moving the porous plate 31 to which the flexible sheet 5 has been adhered by vacuum suction, relative to the layer forming unit 2 of the additive manufacturing device 1.

As shown in (A) of FIG. 6, first, the additive manufacturing device 1 forms the lowest end portion of the shaped object. In (A) of FIG. 6, the controller 100 causes the drive unit 7 to adjust the height of the base 30. The drive unit 7 adjusts the height of the base 30 so that the top surface of the flexible sheet 5 is at a layer formation height position. When the top surface of the flexible sheet 5 is at the layer formation height position, the controller 100 causes the raw material supply unit 6 to supply a raw material 200 in an amount corresponding to a single layer onto the flexible sheet 5. In the case where the raw material supply unit 6 supplies the raw material 200 while moving in the horizontal direction (Y direction), a force in the horizontal direction may be applied to the flexible sheet 5. In this regard, since the flexible sheet 5 is adhered to the porous plate 31 by vacuum suction, even if the force in the horizontal direction is applied to the flexible sheet 5 during the supply of the raw material, a positional displacement of the flexible sheet 5 in the horizontal direction is prevented.

Subsequently, as shown in (B) of FIG. 6, the controller 100 causes the layer forming unit 2 to be irradiated with light. The layer forming unit 2 irradiates the raw material 200 supplied in (A) of FIG. 6, with light on the basis of CAD data. A photocurable resin contained in the raw material 200 which has been irradiated with light cures. Consequently, a layer 201 of the shaped object is formed. Subsequently, the controller 100 causes the drive unit 7 to adjust the height of the base 30. The drive unit 7 adjusts the height of the base 30 so that the top surface of the flexible sheet 5 is at the layer formation height position. Specifically, the drive unit 7 lowers the base 30 only by an amount corresponding to a single layer.

Subsequently, as shown in (C) of FIG. 6, the controller 100 causes the raw material supply unit 6 to supply the raw material 200 in an amount corresponding to a single layer onto the flexible sheet 5. Consequently, the already formed layer 201 is buried in the raw material 200. The layer forming unit 2 irradiates the supplied raw material 200 with light on the basis of the CAD data. The raw material 200 irradiated with light cures. Thus, the layer 201 of the shaped object is stacked.

(A) of FIG. 7 is one example of the case where the procedure described with reference to (A) to (C) in FIG. 6 was repeated. As shown in (A) of FIG. 6, a shaped object 10 composed of a plurality of layers 201 is formed.

As shown in (B) of FIG. 7, the controller 100 causes the drive unit 7 to adjust the height of the base 30. The drive unit 7 raises the base 30 so that a lower surface of the flexible sheet 5 is at a height position of a top surface of the shaping frame 8. Then, the uncured raw material 200 is collected.

Returning to FIG. 5, the controller 100 stops the pressure reducing operation of the decompression device 4 as a suction adhesion release process (step S16). By stopping the pressure reducing operation of the decompression device 4, the space S inside the base 30 returns to the atmospheric pressure. Consequently, the vacuum suction adhesion between the flexible sheet 5 and the porous plate 31 is released.

Subsequently, as the unloading process (step S18), the operator unloads the shaped object 10 formed on the flexible sheet 5 from the additive manufacturing device 1 together with the flexible sheet 5. As shown in (C) of FIG. 7, since the vacuum suction adhesion has been released, the flexible sheet 5 can be easily removed from the base 30. The unloading process (step S18) may be executed by a robot.

Subsequently, as a separating process (step S20), the operator separates the shaped object 10 and the flexible sheet 5 unloaded from the additive manufacturing device 1. For example, the operator removes the flexible sheet 5 from the shaped object 10 by bending the flexible sheet 5. The separating process (step S20) may be executed by a robot.

Subsequently, the shaped object 10 is transported to a firing device (not shown) and fired (a firing process (step S22)). When the firing process (step S22) is finished, the flowchart comes to an end. By executing the flowchart shown in FIG. 5, the shaped object of ceramics is formed.

As described above, in the stage mechanism 3 according to the embodiment, the pressure in the space S inside the base 30 is reduced by the decompression device 4, and the porous plate 31 adheres the flexible sheet 5 by vacuum suction caused by the pressure difference between the space S and the atmospheric pressure. The base 30 moves up and down to realize stacking of layers on a layer-by-layer basis, while supporting the porous plate 31 to which the flexible sheet 5 is adhered by the vacuum suction. Thus, the layer forming unit 2 can form the shaped object 10 on the flexible sheet 5. When the reducing of the pressure in the space inside the base 30 is stopped, the vacuum suction adhesion to the porous plate 31 is released. When the vacuum suction adhesion is released, the shaped object 10 formed on the flexible sheet 5 is easily separated from the stage mechanism 3 together with the flexible sheet 5. Since the stage mechanism 3 enables removal of the shaped object 10 from the stage mechanism 3 without using a scraper, it is possible to avoid the shaped object 10 or the base plate (porous plate 31) from being scratched. Hence, the stage mechanism 3 is capable of reducing the operation time and obtaining the shaped object of high quality.

The stage mechanism 3 can change the relative position between the base 30 and the layer forming unit 2 by moving the base 30 up and down by the drive unit 7. The stage mechanism 3 can move up and down so that the photocurable resin supplied on the flexible sheet 5 can be irradiated with light on a layer-by-layer basis.

The stage mechanism 3 can be employed when forming a ceramic formed body. Since the ceramic formed body has low toughness, the ceramic formed body tends to crack easily when removing the ceramic formed body from the stage mechanism using a scraper. Since the stage mechanism 3 enables removal of the shaped object 10 from the stage mechanism without using a scraper, it is possible to avoid the ceramic formed body from being scratched.

The stage mechanism 3 can be employed when supplying the raw material 200 of the shaped object 10 onto the flexible sheet 5 by the raw material supply unit 6 moving in the horizontal direction. Since the porous plate 31 can adhere the flexible sheet 5 by vacuum suction, it is possible to prevent a positional displacement of the flexible sheet 5 in the horizontal direction during the supply of the raw material.

Further, according to the additive manufacturing method, since the flexible sheet 5 is used, the shaped object 10 can be easily removed from the stage mechanism 3 without using a scraper. Thus, this additive manufacturing method is capable of reducing the operation time and obtaining the shaped object of high quality. According to the additive manufacturing method, it is possible to easily remove the flexible sheet from the shaped object by bending the flexible sheet. According to the additive manufacturing method, it is possible to prevent a positional displacement of the flexible sheet 5 in the horizontal direction during the supply of the raw material. According to the additive manufacturing method, the shaped object such as a ceramic formed body before firing can be removed from the stage mechanism without using a scraper.

The embodiments have been described above, but the present disclosure is not limited to the above embodiments. For example, the additive manufacturing device and the additive manufacturing method according to the present disclosure are not limited to a system of producing a shaped object by irradiating a photocurable resin with light. For example, the layer forming unit may form a layer by jetting a raw material containing a resin onto the flexible sheet, or by jetting a binder into a raw material supplied on the flexible sheet. The additive manufacturing device and the additive manufacturing method according to the present disclosure cannot employ a system of fusing the flexible sheet like a system of fusing the raw material at a high temperature with a laser or the like (for example, powder bed fusion), but can be employed in any other type of device. As one example, the additive manufacturing device and the additive manufacturing method can form a shaped object by a system, such as vat photopolymerization, material extrusion, binder jetting, sheet lamination, or material jetting. The stage mechanism of the present disclosure can be employed in an additive manufacturing device for forming a shaped object by the above-mentioned system, and can reduce the operation time and obtain the shaped object of high quality.

Moreover, in the additive manufacturing device 1, the layer forming unit 2 may move up and down. Even when operated in such a manner, the base 30 moves up and down relative to the layer forming unit 2. The shape of the base 30 is not limited to the embodiments, and may have a columnar shape. The base 30 may have any shape as long as an internal space is formed. The inlet port 35 may be provided at a location other than the side portion of the base 30. For example, the inlet port 35 may be provided at a bottom portion of the base 30. In short, the inlet port 35 may be provided at any position in the base 30 as long as communicating with the internal space of the base 30.

### Examples

Hereinafter, the effects of the embodiments confirmed by the present inventors will be described.

As the stage mechanism 3, the porous plate 31 made from ceramics was prepared. The porous plate 31 had a porosity of 45%, an average pore diameter of 8 μm, and a length and a width of 265 mm×265 mm. The flexible sheet 5 made from PET with a length and a width of 265 mm×265 mm and a thickness of 50 μm was placed on the stage mechanism 3. Then, the pressure inside the base 30 was reduced to −41 kPa by the decompression device 4. Consequently, the flexible sheet 5 was adhered to the porous plate 31 by vacuum suction.

A ceramic paste was prepared as the raw material. The ceramic paste contained 65 percent by volume of alumina solid, and 35 percent by volume of a photocurable resin and others.

(Securing of Flexible Sheet 5)

Whether the flexible sheet 5 adhered by vacuum suction was displaced during the supply of the material was confirmed. On the flexible sheet 5 adhered by vacuum suction, the ceramic paste was spread in a thickness of 80 μm and a length and a width of 80 mm×80 mm using a scraper. It was confirmed that the flexible sheet 5 adhered by vacuum suction was not displaced during the supply of the material, and the securing strength was sufficient.

(Formation of Shaped Object)

A shaped object having a thickness of 80 μm was obtained by irradiating a range of 50 mm×50 mm in length and width of the ceramic paste on the flexible sheet 5 with ultraviolet light to solidify the paste. Subsequently, the porous plate 31 was lowered by 80 μm. Then, on the shaped object having a thickness of 80 μm and the uncured ceramic paste, the ceramic paste was spread in a thickness of 80 μm and a length and a width of 80 mm×80 mm using a scraper in the same manner as above. The flexible sheet 5 adhered by vacuum suction was secured to the porous plate 31, and no positional displacement of the flexible sheet 5 in the horizontal direction occurred during the operation of spreading the ceramic paste. Then, by irradiating a range of 50 mm×50 mm in length and width with ultraviolet light to solidify the paste, the shaped object having a thickness of 160 μm was obtained. The above-described supply of the ceramic paste and irradiation of ultraviolet light were repeated to obtain the shaped object having 50 layers, a thickness of 4 mm, and a length and a width of 50 mm×50 mm. It was confirmed that it was possible to form the shaped object on the flexible sheet 5 adhered by vacuum suction.

(Unloading of Shaped Object)

After completion of object shaping, unloading of the shaped object was completed by releasing the vacuum suction adhesion of the porous plate 31 and lifting up the flexible sheet 5 with hand. Then, after removing the uncured paste, the flexible sheet 5 was peeled off from the shaped object. Since a scraper was not used, the work load was extremely small, and it was possible to remove the shaped object without being scratched. It was confirmed that no suction mark was created on the shaped object. Thereafter, the shaped object was debindered and fired, and penetrant testing was performed on the shaped object after being fired (fired body). Then, it was confirmed that cracks and separation between the layers did not occur in the fired body.

### Comparative Example

A shaped object was formed on a stainless-steel base plate in the same manner as in the example. After the base plate was detached from the device and washed, the shaped object was removed from the base plate using a metal spatula. In this case, a number of scratches, cracks and deformations occurred on a lower portion of the shaped object.

From the above, it was confirmed that it was possible to reduce the operation time and obtain the shaped object of high quality by using the flexible sheet 5.

### REFERENCE SIGNS LIST

1 . . . additive manufacturing device, 2 . . . layer forming unit, 3 . . . stage mechanism, 4 . . . decompression device, 5 . . . flexible sheet, 6 . . . raw material supply unit, and 7 . . . drive unit.

1. A stage mechanism for use in an additive manufacturing device for forming a three-dimensional shaped object by stacking layers, which are formed by a layer forming unit, on a layer-by-layer basis, the stage mechanism comprising:
a porous plate configured to adhere a flexible sheet by vacuum suction; and
a base supporting the porous plate and having a space defined inside of the base, and an inlet port configured to connect the space and a decompression device,
wherein the base moves up and down relative to the layer forming unit of the additive manufacturing device so that the shaped object is formed on the flexible sheet adhered, by vacuum suction, to the porous plate, and
a pore diameter of the porous plate is less than the thickness of the flexible sheet.

2. The stage mechanism according to claim 1, further comprising a drive unit configured to move up and down the base.

3. The stage mechanism according to claim 1, wherein the layer forming unit forms the layer by irradiating a raw material containing a photocurable resin supplied on the flexible sheet, with light.

4. The stage mechanism according to claim 1, wherein the layer forming unit forms the layer by jetting a raw material containing a resin onto the flexible sheet, or by jetting a binder into a raw material supplied on the flexible sheet.

5. The stage mechanism according to claim 3, wherein the raw material of the shaped object contains a ceramic.

6. The stage mechanism according to claim 1, wherein a raw material of the shaped object is supplied onto the flexible sheet by a raw material supply unit moving in a horizontal direction.

7. (canceled)

8. An additive manufacturing method for manufacturing a three-dimensional shaped object by stacking layers on a layer-by-layer basis, the method comprising:
adhering, by vacuum suction, a flexible sheet to a porous plate provided in a stage mechanism of an additive manufacturing device;
forming the shaped object on the flexible sheet by moving the porous plate to which the flexible sheet has been adhered by vacuum suction, up and down relative to a layer forming unit of the additive manufacturing device;
releasing vacuum suction adhesion between the porous plate and the flexible sheet;
unloading the shaped object formed on the flexible sheet from the additive manufacturing device together with the flexible sheet; and
separating the shaped object and the flexible sheet unloaded from the additive manufacturing device,
wherein a pore diameter of the porous plate is less than the thickness of the flexible sheet.

9. The additive manufacturing method according to claim 8, wherein, in the separating the shaped object and the flexible sheet, the flexible sheet is removed from the shaped object by bending the flexible sheet.

10. The additive manufacturing method according to claim 8, wherein, in the forming the shaped object on the flexible sheet, a raw material of the shaped object is supplied onto the flexible sheet by a raw material supply unit moving in a horizontal direction.

11. The additive manufacturing method according to claim 8, further comprising firing the shaped object from which the flexible sheet has been separated.

12. An additive manufacturing device for manufacturing a three-dimensional shaped object by stacking layers on a layer-by-layer basis, the additive manufacturing device comprising:
a porous plate configured to adhere a flexible sheet by vacuum suction;
a base supporting the porous plate and having a space defined inside of the base, and an inlet port communicating with the space;
a decompression device connected to the inlet port of the base;
a layer forming unit configured to form the layer on the flexible sheet adhered, by vacuum suction, to the porous plate by the decompression device;
a drive unit configured to move the base up and down relative to the layer forming unit; and
a controller configured to control the drive unit so that the shaped object is formed on the flexible sheet adhered, by vacuum suction, to the porous plate by the decompression device,
wherein a pore diameter of the porous plate is less than the thickness of the flexible sheet.

13. The additive manufacturing device according to claim 12, wherein the drive unit moves the base up and down.

14. The additive manufacturing device according to claim 12, wherein the drive unit moves the layer forming unit up and down.

15. The additive manufacturing device according to claim 12, wherein the layer forming unit forms the layer by irradiating a raw material containing a photocurable resin supplied on the flexible sheet, with light.

16. The additive manufacturing device according to claim 12, wherein the layer forming unit forms the layer by jetting a raw material containing a resin onto the flexible sheet, or by jetting a binder into a raw material supplied on the flexible sheet.

17. The additive manufacturing device according to claim 12, wherein a raw material of the shaped object contains a ceramic.

18. The additive manufacturing device according to claim 12, wherein a raw material of the shaped object is supplied onto the flexible sheet by a raw material supply unit moving in a horizontal direction.
